(19) United States
(12) Patent Application Publication
(10) Pub. No.: US 2010/0129712 A1
(43) Pub. Date: May 27, 2010

(54) ENERGY STORAGE DEVICES

(75) Inventors: Fu-Ming WANG, Sijhih City (TW); Chang-Rung Yang, Taiping City (TW); Jyh-Tsung Lee, Linkou Township (TW); Chia-Chen Li, Taipei City (TW); Yung-Ju Chu, Banqiao City (TW); Xing-Wei Peng, Zhudong Town (TW)

Correspondence Address: LOWE HAUPTMAN HAM & BERNER, LLP, 1700 DIAGONAL ROAD, SUITE 300, ALEXANDRIA, VA, 22314, US

(73) Assignee: INDUSTRIAL TECHNOLOGY RESEARCH INSTITUTE, Hsinchu (TW)

(21) Appl. No.: 12/401,409

(22) Filed: Mar. 10, 2009

(30) Foreign Application Priority Data
Nov. 25, 2008 (TW) 097145454

(51) Int. Cl. H01M 4/62

(52) U.S. Cl. 429/217

(57) ABSTRACT

An energy storage device is provided. The energy storage device includes a positive electrode including a polyacrylate aqueous binder blended therewith, a negative electrode and an electrolyte. The polyacrylate aqueous binder is as shown in Formula (I):

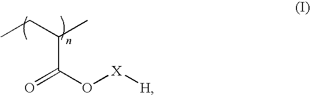

wherein
X is C1-6 alkyl and n is 500-2,500.

### CROSS REFERENCE TO RELATED APPLICATIONS

This Application claims priority of Taiwan Patent Application No. 97145454, filed on Nov. 25, 2008, the entirety of which is incorporated by reference herein.

### BACKGROUND OF THE INVENTION

1. Field of the Invention

The invention relates to an energy storage device, and more particularly to an energy storage device with a positive electrode comprising a polyacrylate aqueous binder blended therewith.

2. Description of the Related Art

With development of portable electronic and mobile devices, an energy storage device with high energy capacity, and rapid charge/discharge and long-term use capabilities is desirable.

Generally, energy storage devices are divided into batteries and capacitors.

For batteries, electric energy is stored through chemical redox, in accordance with long-term small current discharge. Thus, high-energy-density electrode materials capable of long-term use are required.

Currently, most of the binders utilized in positive electrode systems are mainly oily. Meanwhile, development of proper aqueous binders to be applied in the lithium battery industry is desirable due to environmental pollution caused by organic solvents and the high cost of fluorine-containing binders. However, current commercial aqueous binders utilized in positive electrode material, for example, polyacrylonitrile and styrene-butadiene rubber (SBR), cause low adhesion and large positive electrode resistance, thus deteriorating battery properties.

### BRIEF SUMMARY OF THE INVENTION

One embodiment of the invention provides an energy storage device comprising a positive electrode comprising a polyacrylate aqueous binder blended therewith, a negative electrode and an electrolyte.

The positive electrode comprises LiCoO₂, LiMn₂O₄, LiFePO₄, LiN_{1/3}Co_{1/3}Mn_{1/3}O₂ or LiNiCoO₂.

The polyacrylate aqueous binder is as shown in Formula (I):

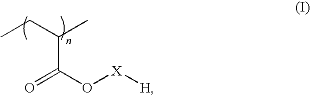

wherein

X is C1-6 alkyl and n is 500-2,500. X further comprises acrylate.

The polyacrylate aqueous binder has a molecular weight of 10,000-200,000. The positive electrode further comprises a polyacrylonitrile aqueous binder blended therewith.

The polyacrylonitrile aqueous binder is as shown in Formula (II):

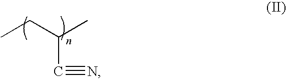

wherein

n is 500-3,500.

The polyacrylonitrile aqueous binder has a molecular weight of 20,000-150,000. The polyacrylate aqueous binder and the polyacrylonitrile aqueous binder have a weight ratio of 1:9-5:5. The polyacrylate aqueous binder has a weight ratio of 1-10 parts by weight, based on 100 parts by weight of the positive electrode. The polyacrylate aqueous binder and the polyacrylonitrile aqueous binder have a weight ratio of 1-10 parts by weight, based on 100 parts by weight of the positive electrode.

For conventional lithium batteries, the adhesion of positive electrodes is effectively improved by replacing the conventional aqueous binder with the aqueous binder prepared by mixing polyacrylate and polyacrylonitrile with a specific ratio. The resistance of the positive electrode is also substantially reduced due to improvement of polarity between the material particles and the binder. Additionally, a battery using the hybrid aqueous binder of the invention effectively maintains a capacitance of 140 mAh/g and has higher efficiency and superior battery properties than that of conventional batteries using a conventional aqueous binder under 0.2 C/0.2 C cycle number.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawing, wherein:

FIG. 1 shows adhesion and surface resistance of various positive electrodes according to an embodiment of the invention.

FIG. 2 shows discharge curves of various energy storage devices under various discharge rates according to an embodiment of the invention.

FIG. 3 shows capacitances of various positive electrodes under various cycle numbers according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

One embodiment of the invention provides an energy storage device comprising a positive electrode comprising a polyacrylate aqueous binder blended therewith, a negative electrode and an electrolyte.

The positive electrode may comprise LiCoO₂, LiMn₂O₄, LiFePO₄, LiNi_{1/3}Co_{1/3}Mn_{1/3}O₂ or LiNiCoO₂.

The polyacrylate aqueous binder is as shown in Formula (I):

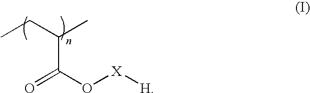

In Formula (I), X may be C1-6 alkyl. n may be 500-2,500. In one embodiment, X may further comprise acrylate. The polyacrylate aqueous binder has a molecular weight of about 10,000-200,000.

In one embodiment, the positive electrode may further comprise a polyacrylonitrile aqueous binder blended therewith.

The polyacrylonitrile aqueous binder is as shown in Formula (II):

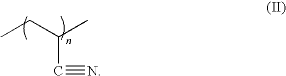

In Formula (II), n may be 500-3,500. The polyacrylonitrile aqueous binder has a molecular weight of about 20,000-150,000.

The polyacrylate aqueous binder and the polyacrylonitrile aqueous binder have a weight ratio of about 1:9-5:5 or 3:7. The polyacrylate aqueous binder has a weight ratio of about 1-10 parts by weight, based on 100 parts by weight of the positive electrode. The polyacrylate aqueous binder and the polyacrylonitrile aqueous binder have a weight ratio of about 1-10 parts by weight, based on 100 parts by weight of the positive electrode.

For conventional lithium batteries, the adhesion of positive electrodes is effectively improved by replacing the conventional aqueous binder with the aqueous binder prepared by mixing polyacrylate and polyacrylonitrile with a specific ratio. The resistance of the positive electrode is also substantially reduced due to improvement of polarity between the material particles and the binder. Additionally, a battery using the hybrid aqueous binder of the invention effectively maintains a capacitance of 140 mAh/g and has higher efficiency and superior battery properties than that of conventional batteries using a conventional aqueous binder under 0.2 C/0.2 C cycle number.

### EXAMPLE 1

### Preparation of a Positive Electrode Containing a Polyacrylonitrile Aqueous Binder

First, 91 parts by weight of LiCoO₂, 6 parts by weight of polyacrylonitrile (n=1,300) and 4 parts by weight of acetylene black (conductive powder) were dispersed in NMP to form a slurry. Next, the slurry was coated on an aluminum foil. After drying, being compressed and cut, a positive electrode was prepared.

2 parts by volume of PC, 3 parts by volume of EC, 5 parts by volume of DEC and LiPF₆ were mixed to prepare an electrolyte (1M). Next, an isolation membrane (PP) was disposed between an anode and a lithium cathode to separate one another. The electrolyte was then added between the anode and the cathode. After packaging, an electrochemical test was performed.

### EXAMPLE 2

### Preparation of a Positive Electrode Containing Styrene-Butadiene Rubber (SBR) and Polyacrylonitrile Aqueous Binders

First, 91 parts by weight of LiCoO₂, 6 parts by weight of a mixture of SBR and polyacrylonitrile (n=1,300) (SBR/polyacrylonitrile=3/7) and 4 parts by weight of acetylene black (conductive powder) were dispersed in NMP to form a slurry. Next, the slurry was coated on an aluminum foil. After drying, being compressed and cut, a positive electrode was prepared.

2 parts by volume of PC, 3 parts by volume of EC, 5 parts by volume of DEC and LiPF₆ were mixed to prepare an electrolyte (1M). Next, an isolation membrane (PP) was disposed between an anode and a lithium cathode to separate one another. The electrolyte was then added between the anode and the cathode. After packaging, an electrochemical test was performed.

### EXAMPLE 3

### Preparation of a Positive Electrode Containing the Polyacrylate and Polyacrylonitrile Aqueous Binders

First, 91 parts by weight of LiCoO₂, 6 parts by weight of a mixture of polyacrylate (X=butyl, n=1,500) and polyacrylonitrile (n=1,300) (polyacrylate/polyacrylonitrile=3/7) and 4 parts by weight of acetylene black (conductive powder) were dispersed in NMP to form a slurry. Next, the slurry was coated on an aluminum foil. After drying, being compressed and cut, a positive electrode is prepared.

2 parts by volume of PC, 3 parts by volume of EC, 5 parts by volume of DEC and LiPF₆ were mixed to prepare an electrolyte (1M). Next, an isolation membrane (PP) was disposed between an anode and a lithium cathode to separate one another. The electrolyte was then added between the anode and the cathode. After packaging, an electrochemical test was performed.

### EXAMPLE 4

### Preparation of a Positive Electrode Containing the Polyacrylate and Polyacrylonitrile Aqueous Binders

First, 91 parts by weight of LiCoO₂, 6 parts by weight of a mixture of polyacrylate (X=butyl, n=1,500) and polyacrylonitrile (n=1,300) (polyacrylate/polyacrylonitrile=1/9) and 4 parts by weight of acetylene black (conductive powder) were dispersed in NMP to form a slurry. Next, the slurry was coated on an aluminum foil. After drying, being compressed and cut, a positive electrode is prepared.

2 parts by volume of PC, 3 parts by volume of EC, 5 parts by volume of DEC and LiPF₆ were mixed to prepare an electrolyte (1M). Next, an isolation membrane (PP) was disposed between an anode and a lithium cathode to separate one another. The electrolyte was then added between the anode and the cathode. After packaging, an electrochemical test was performed.

### EXAMPLE 5

### Preparation of a Positive Electrode Containing the Polyacrylate and Polyacrylonitrile Aqueous Binders

First, 91 parts by weight of LiCoO₂, 6 parts by weight of a mixture of polyacrylate (X=butyl, n=1,500) and polyacrylonitrile (n=1,300) (polyacrylate/polyacrylonitrile=5/5) and 4 parts by weight of acetylene black (conductive powder) were dispersed in NMP to form a slurry. Next, the slurry was coated on an aluminum foil. After drying, being compressed and cut, a positive electrode is prepared.

2 parts by volume of PC, 3 parts by volume of EC, 5 parts by volume of DEC and LiPF₆ were mixed to prepare an electrolyte (1M). Next, an isolation membrane (PP) was disposed between an anode and a lithium cathode to separate one another. The electrolyte was then added between the anode and the cathode. After packaging, an electrochemical test was performed.

### EXAMPLE 6

### Adhesion and Surface Resistance of Positive Electrodes

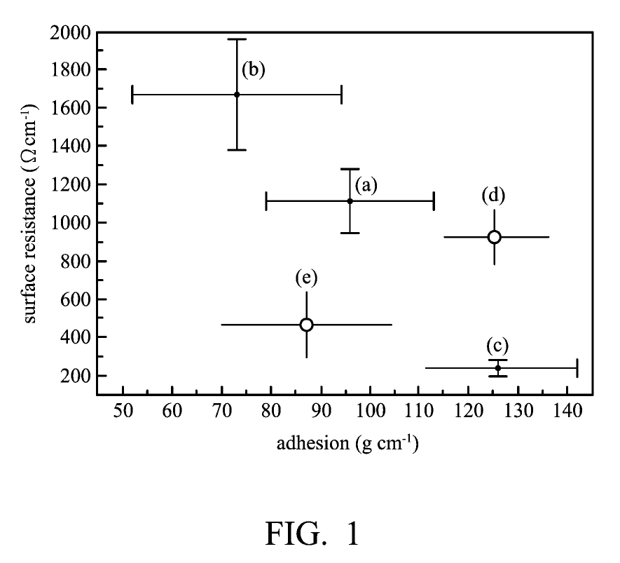

FIG. 1 shows adhesion and surface resistance of various positive electrodes. In the figure, (a) represents the positive electrode containing the polyacrylonitrile aqueous binder, (b) represents the positive electrode containing styrene-butadiene rubber (SBR) and polyacrylonitrile aqueous binders (SBR/polyacrylonitrile=3/7), (c) represents the positive electrode containing the polyacrylate and polyacrylonitrile aqueous binders (polyacrylate/polyacrylonitrile=3/7), (d) represents the positive electrode containing the polyacrylate and polyacrylonitrile aqueous binders (polyacrylate/polyacrylonitrile=1/9) and (e) represents the positive electrode containing the polyacrylate and polyacrylonitrile aqueous binders (polyacrylate/polyacrylonitrile=5/5). The results indicate that the positive electrodes containing the polyacrylate aqueous binder or polyacrylate and polyacrylonitrile aqueous binders have superior adhesion and surface resistance than other positive electrodes.

### EXAMPLE 7

### Charge/Discharge Test and Discharge Curves of Energy Storage Devices

A charge/discharge test of the batteries prepared by Examples 1 and 4 was performed under a fixed current/voltage.

First, the battery was charged to 4.2V at a fixed current of 0.6 mA/cm², until the current was less than or equal to 0.06 mA. Next, the battery was discharged to a cut-off voltage of 2.75V at the fixed current of 0.6 mA/cm². The battery was than charged to 4.2V at a fixed current of 3 mA/cm², until the current was less than or equal to 0.3 mA. Next, the battery was discharged to a cut-off voltage of 2.75V at the fixed current of 3 mA/cm². The battery was than charged to 4.2V at a fixed current of 9 mA/cm², until the current was less than or equal to 0.9 mA. Next, the battery was discharged to a cut-of voltage of 2.75V at the fixed current of 9 mA/cm².

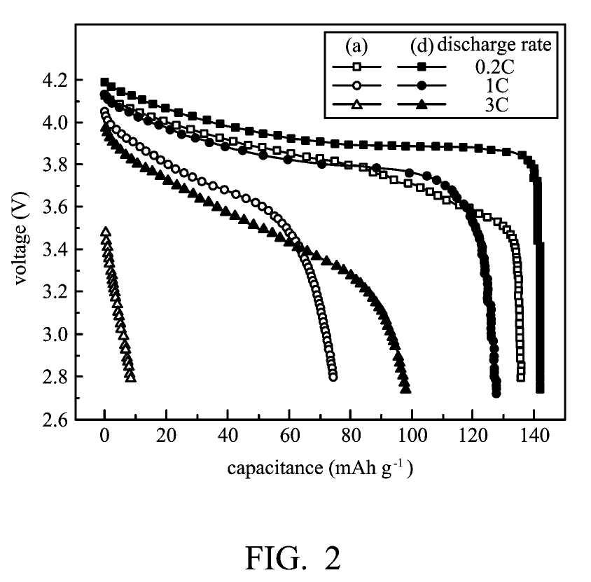

FIG. 2 shows discharge curves of various energy storage devices under various discharge rates. In the figure, (a) represents the energy storage device with the positive electrode containing the polyacrylonitrile aqueous binder and (d) represents the energy storage device with the positive electrode containing the polyacrylate and polyacrylonitrile aqueous binders (polyacrylate/polyacrylonitrile=3/7). The results indicate that the energy storage device with the positive electrode containing the polyacrylate and polyacrylonitrile aqueous binders had superior efficiency (with larger capacitance at the same voltage) than the energy storage device with the positive electrode containing the polyacrylonitrile aqueous binder. With increase in discharge rate, the distinction of battery efficiency increases.

### EXAMPLE 8

### Cycling Stability Test of Energy Storage Devices

A charge/discharge test of the batteries prepared by Examples 1 and 4 was performed under a fixed current/voltage.

First, the battery was charged to 4.2V at a fixed current of 0.6 mA/cm², until the current was less than or equal to 0.061 mA. Next, the battery was discharged to a cut-off voltage of 2.75V at the fixed current of 0.6 mA/cm². The charge/discharge step was repeated for 30 times.

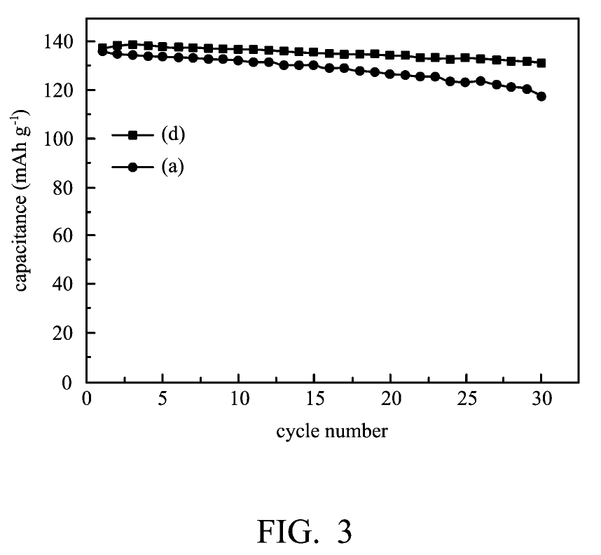

FIG. 3 shows capacitances of various positive electrodes under various cycle numbers. In the figure, (a) represents the energy storage device with the positive electrode containing the polyacrylonitrile aqueous binder and (d) represents the energy storage device with the positive electrode containing the polyacrylate and polyacrylonitrile aqueous binders (polyacrylate/polyacrylonitrile=3/7). The results indicate that the energy storage device with the positive electrode containing the polyacrylate and polyacrylonitrile aqueous binders maintains larger capacitance than the energy storage device with the positive electrode containing the polyacrylonitrile aqueous binder after various cycle numbers, with greater reliability.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An energy storage device, comprising:
a positive electrode comprising a polyacrylate aqueous binder blended therewith;
a negative electrode; and
an electrolyte.

2. The energy storage device as claimed in claim 1, wherein the positive electrode comprises LiCoO₂, LiMn₂O₄, LiFePO₄, LiNi_{1/3}Co_{1/3}Mn_{1/3}O₂ or LiNiCoO₂.

3. The energy storage device as claimed in claim 1, wherein the polyacrylate aqueous binder is as shown in Formula (I): 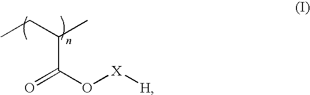
wherein
X is C1-6 alkyl and n is 500-2,500.

4. The energy storage device as claimed in claim 3, wherein X further comprises acrylate.

5. The energy storage device as claimed in claim 4, wherein the polyacrylate aqueous binder has a molecular weight of 10,000-200,000.

6. The energy storage device as claimed in claim 1, wherein the positive electrode further comprises a polyacrylonitrile aqueous binder blended therewith.

7. The energy storage device as claimed in claim 6, wherein the polyacrylonitrile aqueous binder is as shown in Formula (II): 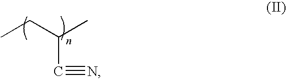
wherein
n is 500-3,500.

8. The energy storage device as claimed in claim 7, wherein the polyacrylonitrile aqueous binder has a molecular weight of 20,000-150,000.

9. The energy storage device as claimed in claim 6, wherein the polyacrylate aqueous binder and the polyacrylonitrile aqueous binder have a weight ratio of 1:9-5:5.

10. The energy storage device as claimed in claim 6, wherein the polyacrylate aqueous binder and the polyacrylonitrile aqueous binder have a weight ratio of 3:7.

11. The energy storage device as claimed in claim 1, wherein the polyacrylate aqueous binder has a weight ratio of 1-10 parts by weight, based on 100 parts by weight of the positive electrode.

12. The energy storage device as claimed in claim 6, wherein the polyacrylate aqueous binder and the polyacrylonitrile aqueous binder have a weight ratio of 1-10 parts by weight, based on 100 parts by weight of the positive electrode.
